(19) United States
(12) Patent Application Publication
(10) Pub. No.: US 2007/0029517 A1
(43) Pub. Date: Feb. 8, 2007

(54) Spherical disc valve configured for gravity fed powders

(75) Inventor: James Lenihan, Somerset, NJ (US)

Correspondence Address: RATNERPRESTIA, P O BOX 980, VALLEY FORGE, PA, 19482-0980, US

(73) Assignee: Gemco Valve Company

(21) Appl. No.: 11/197,556

(22) Filed: Aug. 4, 2005

(51) Int. Cl. F16K 27/08

(52) U.S. Cl. 251/304; 251/367

(57) ABSTRACT

A spherical disc valve is provided. The spherical disc valve comprises a valve body including body portions positioned adjacent one another. The body portions each have a collar portion, wherein the collar portions of the body portions are substantially aligned and together define an aperture. A valving member including a shaft segment is positioned within the aperture, wherein the valving member is configured to rotate about an axis defined by the shaft segment for selectively closing and opening the disc valve. A clamping member is positioned about the collar portions of the body portions, the clamping member being configured to urge the collar portions toward the shaft segment and maintain the body portions adjacent one another.

### FIELD OF THE INVENTION

The present invention relates to a spherical disc valve configured for use with materials such as gravity fed powders.

### BACKGROUND OF THE INVENTION

Spherical disc valves are used to control the flow of matter and are used in a variety of industries, e.g. plastics, minerals, metal powders, sand, gravel, fly ash, cosmetics, pharmaceutical, neutraceutical, nuclear, food and most processing industries. Spherical disc valves commonly comprise a valve body and a pivotable valving member mounted therein. The valve body includes an inlet port to receive matter and an outlet port to dispense matter. In a closed configuration of the disc valve, the pivotable valving member is in sealing contact with the inlet port, thereby inhibiting the flow of matter through the valve. In an open configuration of the disc valve, the pivotable valving member is partially or entirely separated from the inlet of the valve body, thereby permitting the flow of matter through the valve. The matter may be a powder, granule, pellet, or any other particle, fluid or slurry.

The inlet port of the valve body may receive particulate matter from, for example, a hopper and the outlet port of the valve body may distribute the matter to, for example, a processing apparatus or a conduit. A pneumatic or manually controlled actuator coupled to the pivotable valving member controls the position of the valving member relative to the inlet port to permit or inhibit the flow of matter through the disc valve. The principles of operation of a spherical disc valve are disclosed in U.S. Pat. No. 4,137,935, which is incorporated herein by reference in its entirety.

Regular maintenance and cleaning of the valve may be necessary to promote longevity of the valve and to maintain purity of the matter contained therewithin. In practice, for maintenance purposes, the disc valve is periodically disassembled, sanitized and then reassembled. The downtime of the valve body is desirably minimized to avoid a detrimental economic impact to the industrial or other production cycle and to reduce maintenance manpower costs. Furthermore, in some circumstances, a seal is desirably reestablished upon reassembly of the disc valve to limit leakage of matter from the valve body.

Accordingly, there continues to be a need for a spherical disc valve which can be conveniently disassembled and reassembled, while concurrently retaining its performance characteristics.

### SUMMARY OF THE INVENTION

In one exemplary embodiment, a spherical disc valve is provided. The spherical disc valve comprises a valve body including body portions positioned adjacent one another. The body portions each have a collar portion, wherein the collar portions of the body portions are substantially aligned and together define an aperture. A valving member including a shaft segment is positioned within the aperture, wherein the valving member is configured to rotate about an axis defined by the shaft segment for selectively closing and opening the disc valve. A clamping member is positioned about the collar portions of the body portions, the clamping member being configured to urge the collar portions toward the shaft segment and maintain the body portions adjacent one another.

In another aspect of the invention, a method of assembling a spherical disc valve comprising a valve body and a valving member is provided. The method comprises the step of positioning a shaft segment of the valving member within a collar portion of a first body portion of the valve body. A second body portion of the valve body with a collar portion is positioned adjacent the collar portion of the first body portion such that the collar portions are substantially aligned and substantially capture the shaft segment of the valving member, thereby permitting the shaft segment to rotate about its axis with respect to the collar portions. The collar portions are then clamped to maintain the first and second body portions of the valve body adjacent one another.

In another exemplary embodiment, a spherical disc valve is provided. The spherical disc valve comprises a valve body including two body portions positioned adjacent one another. A mounting portion is positioned on each of the body portions and at least one fastener is configured to engage the mounting portions, thereby substantially preventing passage of matter at an interface of the body portions. The fastener comprises a shaft portion extending substantially normal to a plane of the interface and at least two grasping portions extending radially outwardly from the shaft portion.

### BRIEF DESCRIPTION OF THE DRAWINGS

The invention is best understood from the following detailed description when read in connection with the accompanying drawing. It is emphasized that, according to common practice, the various features of the drawing may not be to scale. On the contrary, the dimensions of the various features may be arbitrarily expanded or reduced for clarity. Included in the drawing is the following figure:

FIG. 1A is a front elevation view of an exemplary embodiment of a spherical disc valve coupled with an actuator according to aspects of this invention;

FIG. 1B is a top plan view of the spherical disc valve and actuator illustrated in FIG. 1A;

FIG. 1C is a detail cross-sectional front view of the spherical disc valve illustrated in FIG. 1B taken along the lines 1C-1C;

FIG. 2A is a right elevation view of an exemplary embodiment of a valve body component of the spherical disc valve illustrated in FIG. 1A;

FIG. 2B is a right elevation view of a top portion of the valve body illustrated in FIG. 2A;

FIG. 2C is a right elevation view of a bottom portion of the valve body illustrated in FIG. 2A;

FIG. 2D is a front partial cross sectional view of the valve body illustrated in FIG. 2A;

FIG. 3A is a front elevation view of an exemplary embodiment of a valving member component of the spherical disc valve illustrated in FIG. 1C;

FIG. 3B is a right elevation view of the valving member illustrated in FIG. 3A;

FIG. 4A is an end elevation view of an exemplary embodiment of a bushing component of the spherical disc valve illustrated in FIG. 1C;

FIG. 4B is a cross-sectional front view of the bushing illustrated in FIG. 4A taken along the lines 4B-4B;

FIG. 5A is a front elevation view of an exemplary embodiment of a retaining ring component of the spherical disc valve illustrated in FIG. 1C;

FIG. 5B is a top elevation view of the retaining ring illustrated in FIG. 5A;

FIG. 6A is a right elevation view of an exemplary embodiment of a clamp component of the spherical disc valve illustrated in FIG. 1C;

FIG. 6B is a cross-sectional front view of the clamp illustrated in FIG. 6A, taken along the lines 6B-6B;

FIG. 7A is a top plan view of an exemplary embodiment of a collar clamp component of the spherical disc valve illustrated in FIG. 1C;

FIG. 7B is a cross-sectional front view of the collar clamp illustrated in FIG. 7A, taken along the lines 7B-7B;

FIG. 8A is a left elevation view of another exemplary embodiment of a spherical disc valve and actuator according to aspects of this invention;

FIG. 8B is a top plan view of the spherical disc valve illustrated in FIG. 8A;

FIG. 9A is a left elevation view of yet another exemplary embodiment of a spherical disc valve and actuator according to aspects of this invention; and

FIG. 9B is a top plan view of the spherical disc valve illustrated in FIG. 9A.

### DETAILED DESCRIPTION OF THE INVENTION

The invention will next be illustrated with reference to the Figures. Such Figures are intended to be illustrative rather than limiting and are included herewith to facilitate explanation of the present invention. The Figures are not to scale, and are not intended to serve as engineering drawings.

Referring generally to the figures, a spherical disc valve 12, 112, 212 comprises a valve body 24, 124, 224 including body portions 26, 28, 126, 128, 226, 228 positioned adjacent one another. The body portions each have a collar or ferrule portion 32, 34 (e.g., a half of a ferrule mounted on each body portion), wherein the collar portions of the body portions are substantially aligned and together define an aperture 44. A valving member 22 including a shaft segment 20, 20′ is positioned within the aperture 44, wherein the valving member is configured to rotate about an axis defined by the shaft segment for selectively closing and opening the disc valve 12, 112, 212. A clamping member 36 is positioned about the collar portions 32, 34 of the body portions, the clamping member being configured to urge the collar portions toward the shaft segment 20, 20′ and maintain the body portions adjacent one another.

In another aspect of the invention, a method of assembling a spherical disc valve 12, 112, 212 comprising a valve body 24, 124, 224 and a valving member 22 is provided. The method comprises the step of positioning a shaft segment 20, 20′ of the valving member within a collar portion 34 of a first body portion 28, 128, 228 of the valve body 24. A second body portion 26, 126, 226 of the body with a collar portion 32 is positioned adjacent the collar portion of the first body portion 28, 128, 228 so that the collar portions 32, 34 are substantially aligned and substantially capture the shaft segment 20, 20′ of the valving member 22, thereby permitting the shaft segment to rotate about its axis with respect to the collar portions. The collar portions 32, 34 are then clamped to maintain the first and second body portions of the valve body adjacent one another.

In another exemplary embodiment, a spherical disc valve 112, 212 is provided. The spherical disc valve comprises a valve body 124, 224 including two body portions 126, 128, 226, 228 positioned adjacent one another. A mounting portion 135, 136, 235, 236 is positioned on each of the body portions and at least one fastener 120, 220 is configured to engage the mounting portions 135, 136, 235, 236, thereby substantially preventing passage of matter at an interface of the body portions 126, 128, 226, 228. The fastener comprises a shaft portion extending substantially normal to a plane of the interface and at least two grasping portions 121, 221 extending radially outwardly from the shaft portion.

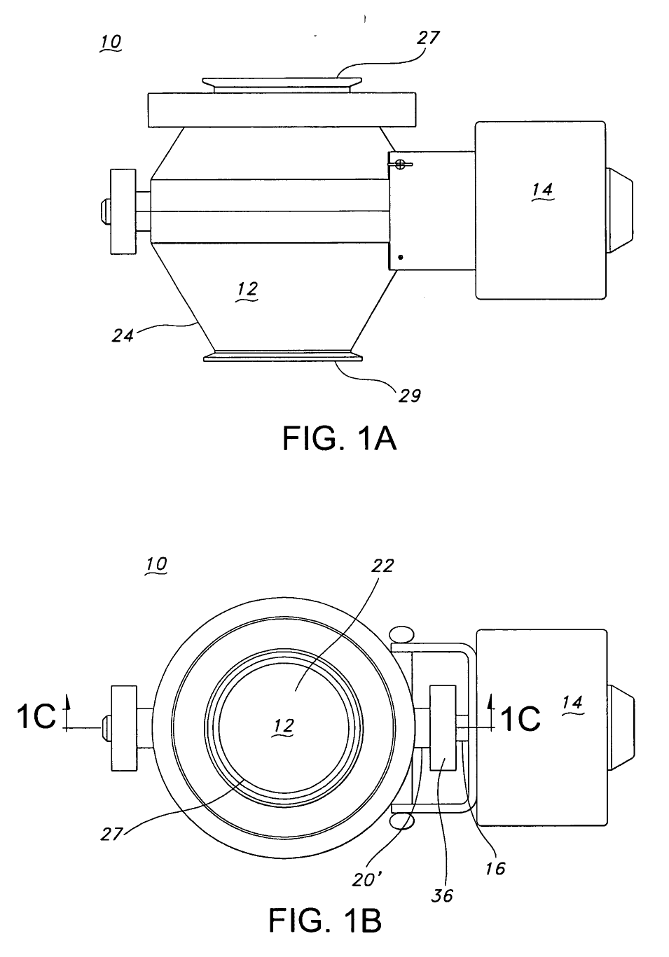

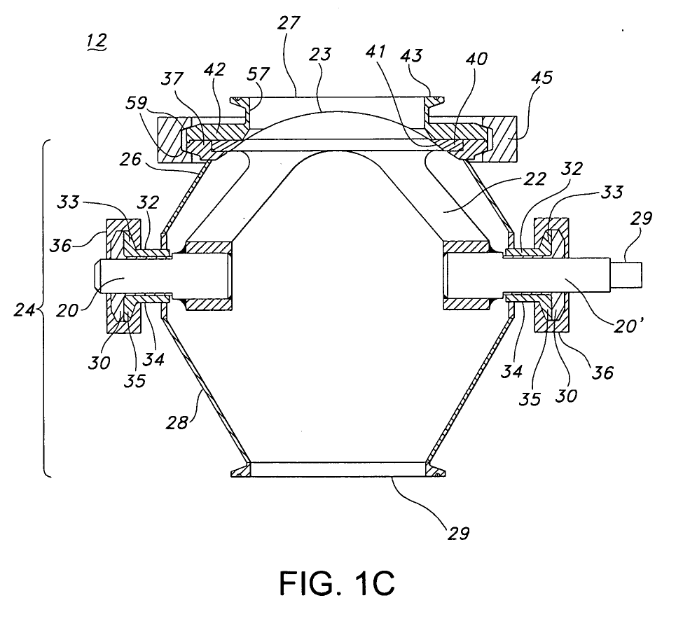

Referring to FIGS. 1A and 1B, a spherical disc valve assembly embodying exemplary aspects of this invention is generally designated by the numeral “10.” Generally, the spherical disc valve assembly 10 comprises a spherical disc valve 12, hereinafter referred to as a disc valve or valve, coupled to an actuator 14. Actuator 14 drives the valve 12. In one exemplary embodiment, a rotating actuator shaft 16 optionally extends from the pneumatically or manually controlled actuator 14. A controller unit, not shown, is optionally embedded within actuator 14 to regulate the rotation of shaft 16.

According to one embodiment, the rotating actuator shaft 16 is optionally coupled to a valve shaft 20′ extending from the valve 12. Accordingly, a rotation of shaft 16 causes the equivalent rotation of shaft 20′.

The rotation of the actuator shaft 16, effects the rotation of a valving member 22 extending from valve shaft 20′. The valve shaft 20′ is pivotably mounted within a valve body 24 (e.g. valve housing) of the valve 12. The valve body 24 comprises an inlet port 27 to receive matter and an outlet port 29 to dispense matter. Although not shown, an apparatus, such as a hopper, positioned above the valve 12 is configured to deliver matter into the inlet port 27 of valve 12 by virtue of gravity or any other force. A conduit or material processor, also not illustrated, is positioned below the valve to receive matter from the valve outlet port 29. The position of the valving member 22 relative to the inlet port 27 of the valve body 24 controls the flow of matter through the valve 12. In a closed configuration of the valve, the valving member 22 is in sealing contact with the inlet port 27, as illustrated in FIGS. 1B and 1C, thereby inhibiting or preventing the flow of matter through the valve. In an open configuration of the disc valve, the valving member 22 is partially or entirely separated from the inlet port 27, thereby permitting the flow of matter through the valve (e.g. matter flows from the hopper into the conduit).

Referring generally to the structure of the valve 12 illustrated in FIG. 1C, the valve 12 includes a valve body 24 having two distinct portions, i.e. top portion 26 and bottom portion 28, positioned together. An aperture is provided at the interface of the valve body portions 26 and 28 to accommodate two hollow bushings 30. The valve shafts 20, 20′ are pivotably seated within the respective bushings 30. A set of adjustable clamps 36 are positioned about the bushings 30 and the top and bottom portions. The clamps 36 compress the top portion 26 and bottom portion 28 together and constrict the bushings 30 about the valve shafts 20 and 20′. The bushing 30 is constricted so that it is fixed in position to permit rotation of the valve shafts 20 and 20′.

In the closed configuration of the disc valve 12, as shown in FIG. 1C, the valving member 22 is maintained in sealing contact with a valve seat 40 that is positioned above the top portion 26. A retaining ring 42 is positioned above the valve seat 40 to accept matter from the dispensing apparatus. An adjustable collar clamp 45 is fastened around the top portion 26, valve seat 40 and retaining ring 42 to compress and substantially seal the components together.

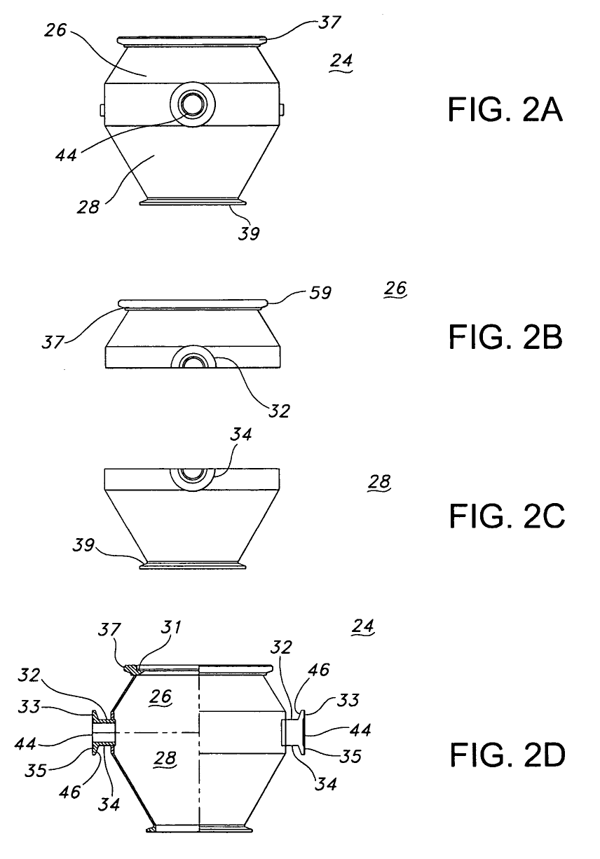

Referring now to the discrete components of the valve 12, FIGS. 2A-2D illustrate an exemplary embodiment of a valve body 24. The valve body 24 comprises two separable hollow portions, i.e. top portion 26 and bottom portion 28. The portions 26 and 28 are shaped and sized to accommodate the rotation of the valving member 22 therein as well as to limit the buildup of matter within the valve body 24. The top and bottom portions are separable about the interface therebetween for ease of assembly and disassembly. As mentioned above, the disc valve 12 is disassembled for periodic maintenance and cleaning and subsequently reassembled. The mating surfaces at the interface of the portions 26 and 28 may be flat, as shown, or formed in a tongue-and-groove type configuration or any other mating configuration. The interface may optionally be dust-tight to limit any matter from penetrating the valve body 24. Although not illustrated herein, a sealing member may be positioned around the circular interface of the body portions 26 and 28 to enhance sealing at the interface. The sealing member, for example, may be an o-ring oriented in a face seal or a lip seal configuration.

The top and bottom portions 26 and 28 of the valve body 24 include opposing collar portions 32 and 34, respectively. The collar portions extend outwardly from the valve body portions. In assembly, the collar portions 32 and 34 are axially aligned to form a cylindrical aperture 44 therethrough to accommodate the bushings 30 and valve shaft segments 20 and 20′. The collar portions 32 and 34 include revolved shoulder segments 33 and 35 extending radially outwardly from the collar portions 32 and 34, respectively. In a united state, the shoulder portions together define a complete shoulder. In use, the clamp 36 sandwiches the bushing and shoulder segments 33 and 35 together to substantially seal the interface between the valve body portion, the interface between the bushing 30 and shoulder segments 33, 35, and the interface between the bushings 30 and valve shafts 20 and 20′. The operation of the clamp 36 will be discussed in further detail later.

In this exemplary embodiment, the arc-lengths of the top and bottom collar portions 32 and 34 are substantially equivalent, i.e. the interior circumference of each collar portion represents approximately one-half of the circumference of the cylindrical aperture 44, however the arc-lengths of either collar portion may be any other dimension to achieve the same purpose.

A top flange 37 disposed on the top portion 26 of the valve body defines a cylindrical channel 31 to accommodate the valve seat 40 and a substantially planar mating surface to seat the retaining ring 42. The bottom flange 39 of the bottom portion 28 is configured to couple with a conduit or other device. Although not illustrated, an additional clamp may be positioned about the bottom flange 39 to secure the flange 39 to a conduit or other device.

The top and bottom portions 26 and 28 of the valve body may be formed by any process, such as, fabrication (e.g., cutting, bending, or welding), die casting, injection molding or machining and composed of any appropriate material such as aluminum, steel, stainless steel, carbon steel, nickel alloys or copper. The collar portions 32 and 34 may be formed from a ferrule, tube, pipe or other revolved structure that is cut in half and welded to the top and bottom portions 26 and 28, respectively. The collars portions may also be fastened to the top and bottom portions of the valve body 24 by any appropriate fastening means known in the art, such as by adhesive, mechanical fasteners, etc. Alternatively, the collars 32 and 34 may be integrally formed (e.g. molded) with the top and bottom portions 26 and 28. Similar to the collar portions, the top flange 37 and bottom flange 39 of the valve body 24 may either be integrally formed with or attached to the top and bottom portions 26 and 28, respectively.

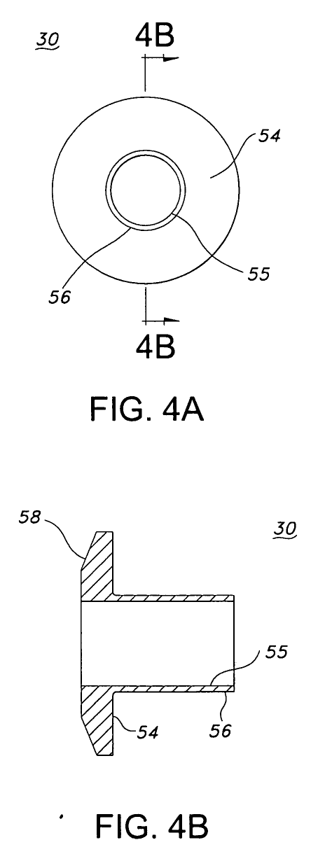

It should be understood that the interior surface of the collars 32 and 34 are not limited to semi-circular form, as the collars may be, for example, rectangular, square or hexagonal. In such case, the outer surface 56 of the bushing (see FIG. 4B) is desirably rectangular, square or hexagonal, respectively, to retain the bushing in a fixed position, and the interior surface 55 of the bushing is optionally cylindrical to receive the pivotable valve shaft 20.

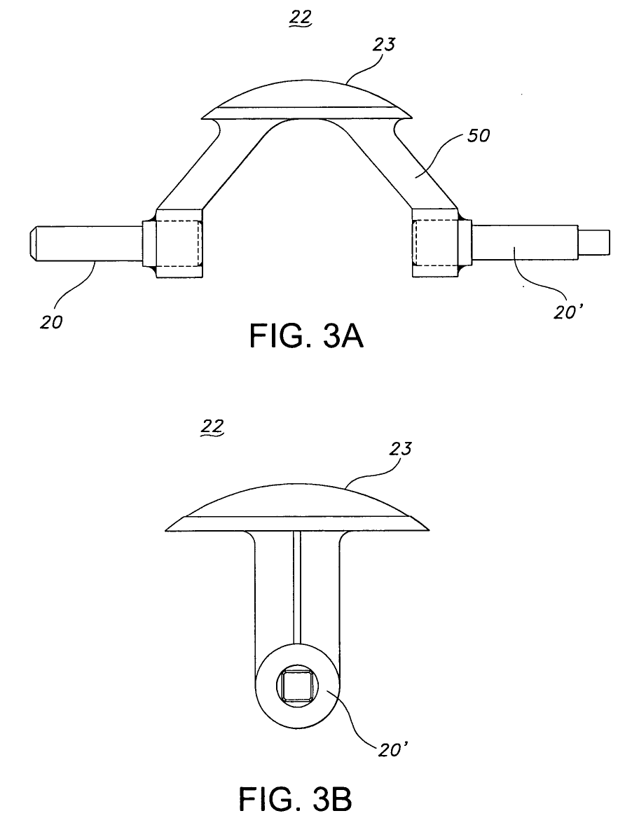

The valving member 22, as best illustrated in FIGS. 3A and 3B, comprises two concentric shaft segments 20 and 20′, and two opposing leg portions 50 extending from the respective shaft segments terminating at a dome surface 23. The valve shaft 20, 20′ is generally cylindrical to rotate about the bushing 30.

The shaft segments 20 and 20′ may either be integrally formed with the valving member 22, or, alternatively, coupled to the valving member (e.g. weld, adhesive, mechanical fasteners, etc.), as shown in FIG. 3A. Moreover, although the shaft is split into two segments 20 and 20′, the shaft may extend along the entire length of the valving member to, perhaps, enhance the structural integrity of the valving member. The valving member 22 may be formed by any process, such as, die casting, molding or machining and composed of any appropriate material such as aluminum, carbon steel, stainless steel, or copper.

Referring now to FIGS. 4A and 4B, the bushing 30 is generally a cylindrically revolved, hollow sleeve that are positioned between the collar portions 32 and 34 and the valve shafts 20 and 20′. The valve shaft 20, 20′ rotates within the interior surface 55 of the bushing. The interior surface 55 is optionally Teflon coated to facilitate the pivotal movement of the shaft 20. Although not shown, a bearing and/or lubricant may also be positioned between the valve shaft 20, 20′ and the bushing 30 to decrease friction therebetween and enhance the operation of the valve 12.

In use, the bushings 30 are held in a substantially fixed position between the collars portions and the valve shafts by the force of the clamps 36. In response to the force of the clamp, the material of the bushing 30 may flow (i.e. deform) to seal any gaps between the valve shafts 20 and 20′ and the bushings as well as gaps between the respective collar portions. The clamp 36 compresses the shoulder 54 of the bushing 30 and the shoulder segments 33 and 35 together, which will be described in further detail later. The bushing may be composed of Teflon, brass, carbon steel, stainless steel, or other appropriate material.

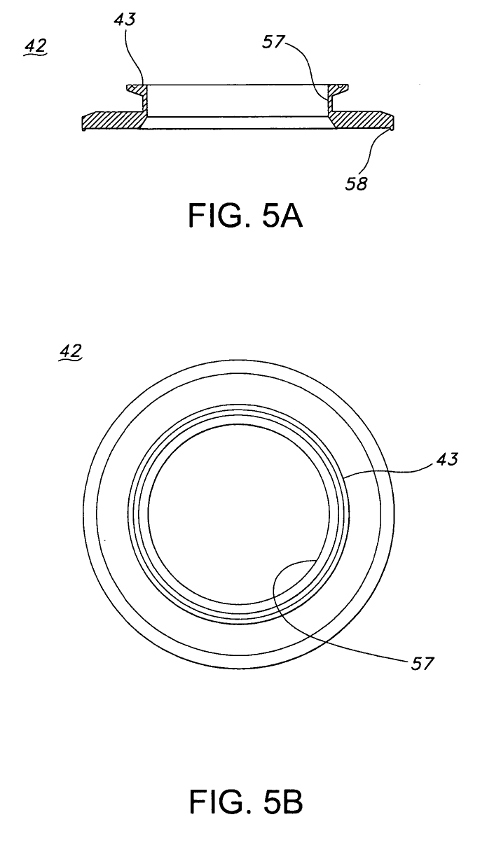

Referring to FIGS. 5A and 5B, the retaining ring 42 is positioned above the top flange 37 of the top portion 26 (FIG. 2D). The top surface 43 of the retaining ring 42 is optionally configured to couple with a hopper or other delivery apparatus. Alternatively, the delivery apparatus may extend into the retaining ring 42 without coupling to the ring 42. The interior revolved surface 57 of the ring 42 embodies the inlet port 27 of the valve to receive matter from the delivery apparatus. A collar clamp 45 compresses the retaining ring 42 and the top portion 26 of the valve body together thereby sealing the interface therebetween and seating the valve seat 40 in channel 31 (see FIG. 2D).

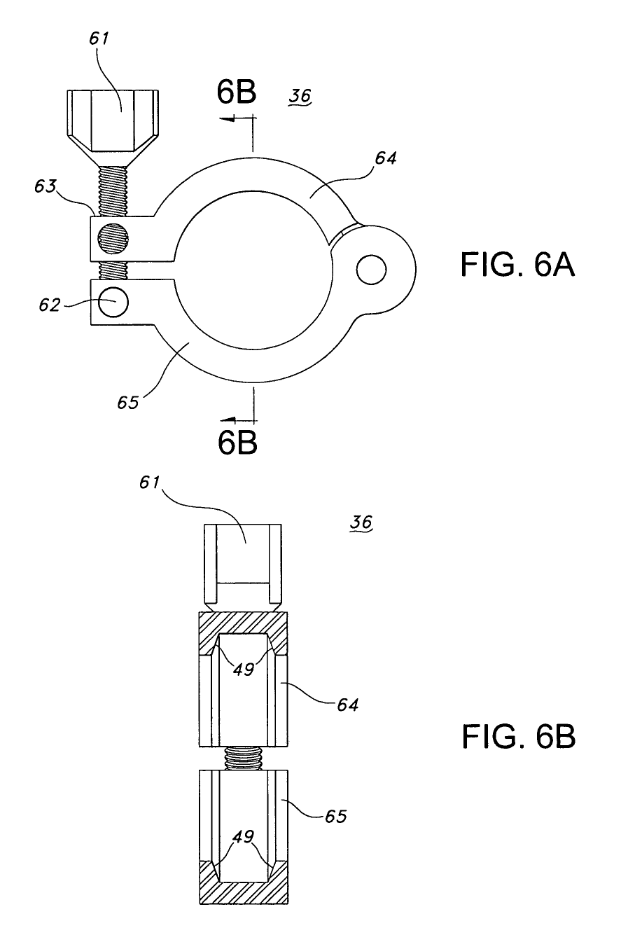

As illustrated in FIGS. 6A and 6B, the clamp 36 is optionally composed of two hingedly connected semi-circular segments, 64 and 65. A fastener 61, e.g. wing nut or other fastener, is threadedly engaged with a rotatable pin 62 captivated within clamp segment 65. In use, the head of the fastener 61 is configured to seat on a mounting surface 63 of clamp segment 64. The head of the fastener 61 engages the mounting surface 63 to incrementally draw the semi-circular segments 64 and 65 together.

The clamp 36 aligns and compresses the collar portions 32 and 34 together, seals the bi-directional interface between the bushings and collar portions, and compresses the bushings 30 against the valve shafts 20, 20′. More particularly, the clamp segments include an angled channel section 49 that is in compressive contact with the chamfered edge 58 of the bushing 30 (see FIG. 4B) and the angled surface 46 of the shoulder segments 33 and 35 (see FIG. 2D) together to form a seal therebetween. The angled and chamfered surfaces facilitate a bi-directional force exerted by the clamp onto the bushing and collar portions. In other words, by virtue of the aforementioned angled surfaces, the clamp is configured to compress the shoulder 54 of the bushing against the shoulder segments 33 and 35 of the collar portions in a first direction, compress the collar portions 32 and 34 together in a second direction, and compress the bushing 30 against the valve shaft 20, 20′ in the second direction.

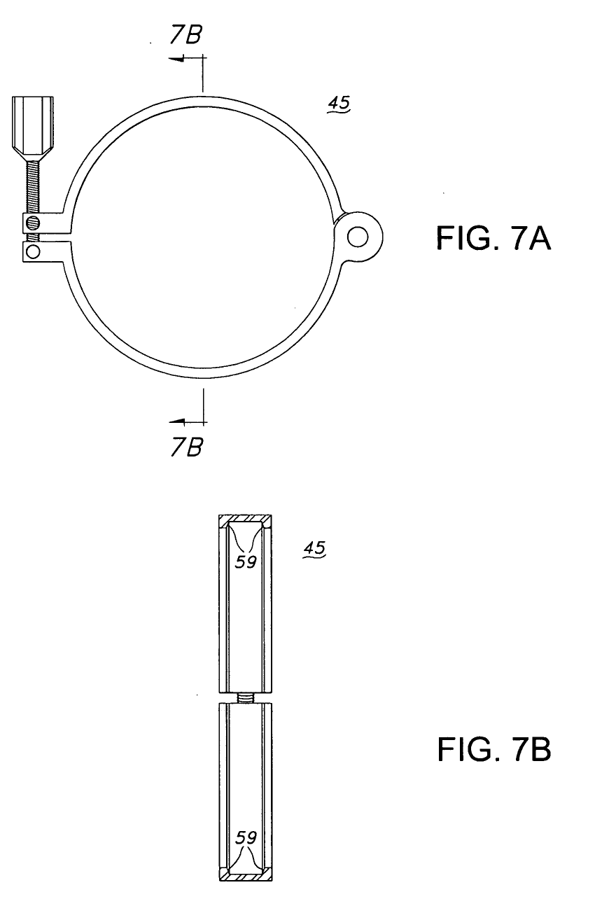

Similar to clamp 36, the collar clamp 45 is positioned about the retaining ring 42 and the top flange 37 to encapsulate the inlet port 27 of the valve 12. The collar clamp 45, best illustrated in FIGS. 7A and 7B, is also optionally composed of two or more hingedly connected segments (e.g., semi-circular segments) with a captive fastener or fasteners mounted thereon, the fastener(s) being manually or mechanically driven. The collar clamp segments include an angled channel section 59 to compress the chamfered edges of the retaining ring 42 and the top flange 37 together to form a seal therebetween.

The clamps 36 and 45 of this exemplary embodiment are advantageous from several perspectives, namely, from an assembly and disassembly perspective, the fasteners 61 are hand adjustable to facilitate rapid assembly and disassembly of the valve without the use of other tools. The fastener 61 of the clamp may also be captivated to the clamp to reduce the risk of detachment upon disassembly and assembly of the valve 12. Furthermore, the clamp is positioned on the exterior of the valve 12 and does not impinge on the interior of the valve. In contrast, many conventional threaded fasteners utilized to secure spherical valves are threaded into the interior portion of the valve. From a sealing perspective, the clamps 36 and 45 maintain the valve body portions 26 and 28 in an evenly compressed state. For example, by virtue of the clamps 36, the entire boundary of the interface between the bottom and top portions of the valve body 24 is desirably maintained in an evenly compressed state. Thus, the seal formed at the aforementioned interface limits matter from penetrating that interface. The clamps 36 and 45 may be a TriClamp or a Quick clamp. A suitable clamp for use with the valve 12 is currently sold and distributed by Alfa Laval, Inc. of Lund, Sweden.

In assembly of the disc valve 12, and according to this exemplary embodiment illustrated in the Figures, each bushing 30 is inserted over the shaft segments 20 and 20′ of the valving member 22. The bushings 30 (along with the valving member) are then positioned within the bottom collars 34 of the valve body bottom portion 28. The top portion 26 of the valve body is positioned over the bottom portion 28 so that the collars 34 and 32 are fittingly aligned and the bushing and valve shafts 20 and 20′ are appropriately captured within the valve body aperture 44. The valve seat 40 is positioned in the channel 31 of the valve body top flange 37 and the retaining ring 42 is positioned over the top flange 37, that is, a revolved lip portion 58 of the retaining ring 42 engages a mating lip portion 59 of the top flange 37. The clamps 36 are positioned over the bushings 30 and collars 32 and 34 on both sides of the valve. The fastener 61 is threadedly inserted into a hole of the clamp 36 to compress the bushing and collars together to seal the interface between the top and bottom portions 26 and 28 of the valve body 24. The collar clamp 45 is then positioned over the retaining ring 42 and the top flange 37. A fastener is threadedly inserted into a hole of the clamp 45 to compress the retaining ring 42 and the top flange 37 together. The steps may be performed in the opposite order to disassemble the disc valve 12.

All of the aforementioned steps can be performed with or without hand or pneumatic tools. Furthermore, although assembly and disassembly steps are described herein, the assembly and disassembly process is not limited to the steps or step order as described. Rather, the assembly order and assembly components may vary widely from the above description.

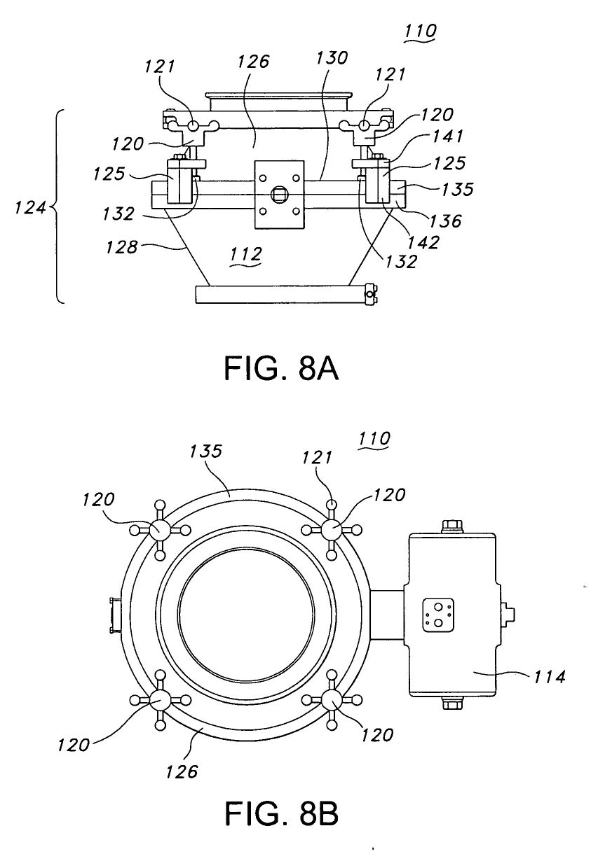

Referring now to FIGS. 8A and 8B, another exemplary embodiment of a spherical disc valve assembly embodying exemplary aspects of this invention is generally designated by the numeral “110.” Similar to the spherical disc valve assembly 10, the spherical disc valve assembly 110 comprises a spherical disc valve 112 coupled to an actuator 114. However, the spherical disc valve 112 of this exemplary embodiment employs a C-clamp style device to seal the top and bottom portions 126 and 128 of the valve body 124 together.

The top and bottom portions 126 and 128 of the valve body 124 include flanges 135 and 136, respectively. The spherical disc valve 112 incorporates a plurality of hand clamps 120 engaged with protruding flanges 125 to seal the flanges 135 and 136 together. The entire boundary of the interface between the bottom and top portions of the valve body 124 is desirably maintained in an evenly compressed state to limit matter from penetrating the interface.

Each hand clamp 120 includes a grasping portion 121, a mounting foot 132 and a threaded shaft portion positioned therebetween. Each protruding flange 125 includes a fixed portion 142 welded to the bottom flange 136 and a top portion 141 that is rotatably mounted to the fixed portion 142. Although not shown, the threaded shaft portion of the hand clamp 120 is threadedly engaged and thereby captivated with a threaded aperture disposed on the top portion 141. The protruding flange 125 and hand clamp 120 are both permanently coupled to the valve body to reduce the risk of dropping and loss of valve components upon assembly and disassembly of the valve.

In use, the rotation of the grasping portion 121 drives the mounting foot 132 toward a mounting surface 130 of the top flange 135. Since the hand clamp 120 is threadedly engaged with the top portion 141 and the fixed portion 142 is welded to the bottom flange 136, the rotation of the grasping portion 121 draws the flanges 135 and 136 together to seal the interface therebetween. To separate the top and bottom portions 126 and 128, the user loosens the hand clamp and rotates the top portion 141 (and the captivated hand clamp 120) away from the valve body 124. The steps are performed in the opposite order to assemble the valve 112.

Although four hand clamps 120 are optionally shown, the valve 112 may include any number of clamps. Furthermore, although the protruding flanges 125 selected for illustration comprise two segments fastened together, the protruding flanges 125 may be formed from a single component and/or may be integrally formed with the flange 136 of the lower portion 128.

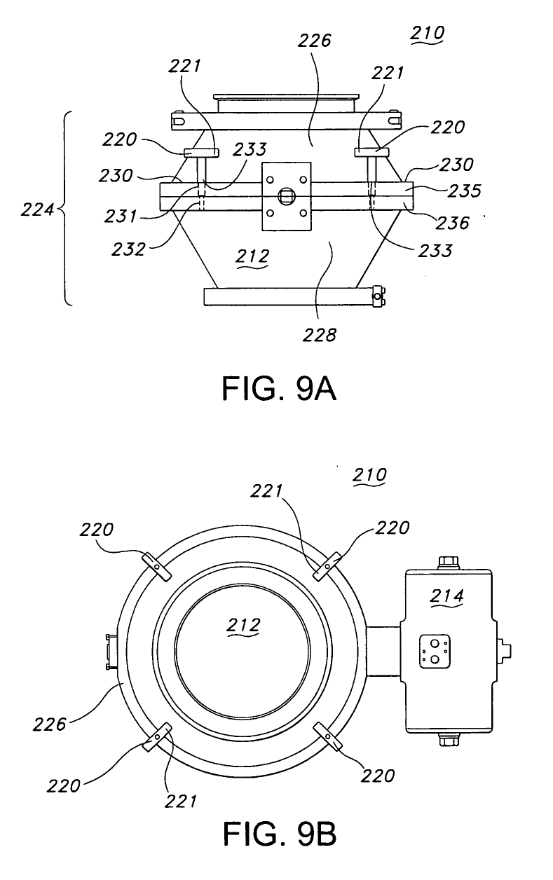

Another exemplary embodiment of a spherical disc valve assembly 210 including a spherical disc valve 212 and an actuator 214, is illustrated in FIGS. 9A and 9B. Similar to the spherical disc valve 112, the valve 212 includes a plurality of T-shaped hand knobs 220. Each threaded end of the hand knob 220 is inserted through a clearance hole 231 disposed on a top flange 235 and is threadedly engaged in a threaded aperture 232 disposed on the bottom flange 236. A mounting surface 233 of the hand knob 220 is configured to abut a mounting surface 230 of the top flange 235 to draw the valve body portions together.

The outwardly extending grasping portions 221 of the hand knobs are provided for ease of handling. In use, the grasping portions 221 provide leverage for the user to easily engage and disengage the hand knobs with the bottom flange 236. The hand knobs 220 may be captive, i.e. attached to the top flange 235, to reduce the risk of dropping and loss of valve components upon assembly and disassembly of the valve. Although four hand knobs are optionally shown, the valve 212 may include any number of knobs.

Although the invention is illustrated and described herein with reference to specific embodiments, the invention is not intended to be limited to the details shown. Rather, various modifications may be made in the details within the scope and range of equivalents of the claims and without departing from the invention.

Specifically, it should be understood that the valve 12 is not limited to the figures selected for illustration. For example, although the valve includes an aperture disposed on opposing sides of the valve body 24, two bushings 30, and opposing shaft segments 20, the valve 12 may optionally include an aperture disposed on a single side of the valve body 24, one bushing and one shaft segment cooperating together to achieve the same purpose. In other words, the valving member may pivot within the valve body 24 about a single shaft segment 20.

What is claimed:

1. A spherical disc valve comprising:
a valve body including body portions positioned adjacent one another, said body portions each having a collar portion, wherein said collar portions of said body portions are substantially aligned and together define an aperture;
a valving member including a shaft segment positioned within said aperture, wherein said valving member is configured to rotate about an axis defined by said shaft segment for selectively closing and opening said disc valve; and
a clamping member positioned about said collar portions of said body portions, said clamping member being configured to urge said collar portions toward said shaft segment and to thereby maintain said body portions adjacent one another.

2. The spherical disc valve of claim 1, each of said collar portions comprising a shoulder portion extending radially outwardly.

3. The spherical disc valve of claim 2, said shoulder portions together defining a substantially continuous shoulder.

4. The spherical disc valve of claim 1, said body portions each having at least two collar portions.

5. The spherical disc valve of claim 4, said collar portions together defining at least two apertures.

6. The spherical disc valve of claim 5, said valving member including at least two shaft segments, each extending through one of said apertures.

7. The spherical disc valve of claim 6 further comprising at least two clamping members positioned about said collar portions of said body portions to urge said collar portions of said body portions toward said shaft segment and to thereby maintain said body portions adjacent one another.

8. The spherical disc valve of claim 4, wherein said collar portions of each of said body portions are respectively aligned along a common axis.

9. The spherical disc valve of claim 4, wherein said at least two collar portions of each of said body portions extend from said body portion in substantially opposite directions.

10. The spherical disc valve of claim 1, wherein said body portions of said valve body directly contact one another.

11. The spherical disc valve of claim 1, further comprising a bushing extending into said aperture along an annular region between said shaft segment of said valving member and said collar portions of said body portions.

12. The spherical disc valve of claim 11, said bushing having a sleeve substantially captivated by said collar portions.

13. The spherical disc valve of claim 12, said sleeve of said bushing defining an interior surface within which said shaft segment of said valving member is rotatable.

14. The spherical disc valve of claim 11, said bushing comprising a metallic material.

15. The spherical disc valve of claim 11, said bushing comprising a non-metallic material.

16. The spherical disc valve of claim 11, said bushing comprising a shoulder portion extending radially outwardly.

17. The spherical disc valve of claim 16, said shoulder being substantially captured between said clamping member and said collar portions.

18. The spherical disc valve of claim 11, said clamping member, said bushing, said collar portions, and said shaft segment of said valving member together forming a barrier to inhibit passage of matter from within said valve body through said aperture defined by said collar portions.

19. The spherical disc valve of claim 18, said clamping member urging said bushing and said collar portions together in a first direction and said clamping member urging said bushing and shaft segment together in a second direction, said second direction substantially normal to said first direction.

20. The spherical disc valve of claim 1, said clamping member comprising segments hingedly connected to one another for movement of said segments between opened and closed positions.

21. In a spherical disc valve including a valve body and a valving member, a method of assembling the spherical disc valve comprising the steps of:
positioning a shaft segment of the valving member within a collar portion of a first body portion of the valve body;
positioning a collar portion of a second body portion adjacent the collar portion of the first body portion such that the collar portions are substantially aligned and substantially capture the shaft segment of the valving member, thereby permitting the shaft segment to rotate about its axis with respect to the collar portions; and
clamping the collar portions to maintain the first and second body portions of the valve body adjacent one another.

22. The method of claim 21 further comprising the step of positioning a bushing in an annular region between the shaft segment of the valving member and the collar portions.

23. The method of claim 22, wherein the clamping step further comprises substantially capturing a shoulder portion of the bushing and the collar portions with a clamping member.

24. The method of claim 23, further comprising the step of forming, with the clamping member, the bushing, the collar portions, and the shaft segment of the valving member, a barrier to inhibit passage of matter from within the valve body through the aperture defined by the collar portions.

25. The method of claim 21, said clamping step comprising moving hingedly connected segments of a clamping member with respect to one another from an opened position to a closed position.

26. A spherical disc valve comprising:
a valve body including body portions positioned adjacent one another;
a mounting portion positioned on each of said body portions; and
at least one fastener configured to engage said mounting portions, thereby substantially preventing passage of matter at an interface of said body portions, said fastener comprising a shaft portion extending substantially normal to a plane of said interface and at least two grasping portions extending radially outwardly from said shaft portion.

27. The spherical disc valve of claim 26 further comprising a flange extending from one of said mounting portions and a threaded aperture defined in said flange.

28. The spherical disc valve of claim 27 wherein said fastener extends through said threaded aperture in said flange to engage the other said mounting portion to compress said mounting portions together.

29. The spherical disc valve of claim 26, said at least one fastener comprising a hand clamp.

30. The spherical disc valve of claim 26 further comprising a clearance hole defined in one of said mounting portions and a threaded hole defined in the other of said mounting portions, wherein said threaded hole is positionable to be axially aligned with said clearance hole.

31. The spherical disc valve of claim 30 wherein said fastener extends through said clearance hole to engage said threaded hole to urge said mounting portions together.
